(19) United States
(12) Patent Application Publication
(10) Pub. No.: US 2012/0199061 A1
(43) Pub. Date: Aug. 9, 2012

(54) Method and apparatus for enhancing live-scan fingerprint reader images

(75) Inventor: Douglas Charles Arndt, Glendora, CA (US)

(73) Assignee: The Hitt Companies

(21) Appl. No.: 12/931,567

(22) Filed: Feb. 4, 2011

(51) Int. Cl. B41K 1/00

(52) U.S. Cl. 118/31.5

(57) ABSTRACT

A method and apparatus for improving the optical boundary between a person's fingerprint ridges and the surface platen of a live-scan imaging apparatus, which includes providing an absorbent pad containing chemicals selected from the nonvolatile, non-fatty alkyl esters of benzoic, salicylic, and anthranilic acids; benzyl alcohol and its non-fatty alkanoic acid esters and esters of benzoic, salicylic, and anthranilic acids and ethers of non-fatty alkyl esters; and the non-fatty alkanoic acid triesters of glycerol, placing the person's finger to be scanned on the surface of the absorbent pad to coat the fingerprint ridges and subsequently placing the person's finger with the coated fingerprint ridges on the imaging apparatus to provide a high contrast between the ridges and valleys of the fingerprint area and a high resolution of the fingerprint ridge details.

### FIELD OF THE INVENTION

The present invention relates to a method and apparatus for enhancing fingerprint images recorded by live-scan electro-optical imaging equipment and more particularly to such a method and apparatus which provides a coating of a liquid composition on the ridges of the finger tips prior to the placement thereof on the recording surface of the equipment.

### BACKGROUND OF THE INVENTION

Live-scan fingerprinting equipment, also known as direct fingerprint readers, are methods of reproducing a person's fingerprint images and then exporting them to remote devices for transmission, storage, comparison, and printing. This method avoids having to produce physical fingerprint cards using ink or chemical reactions and then having to scan them later for search and retention. In addition to capturing fingerprint images, live-scanning is growing in popularity for capturing images of the palms due to legislation concerning major case crimes, such as crimes of sexual assault. Live-scanning may one day be used to capture the footprints of babies in hospitals due to the rise of abductions. Therefore the term “fingerprint” will be used in this application in a generic sense to encompass all dactylographs. such as those corresponding to a person's thumbs, hands, toes, and feet.

Much more can be said about the background of the invention by referring to the prior art of the inventor of the present invention, namely U.S. Pat. No. 5,737,071, Arndt, et al. Of particular importance is the teaching therein of Snell's Law of total internal refraction. Additionally, the inventor has gained considerable experience in the manufacturing and field use of this prior art and knows first-hand its limitations and shortcomings.

One of the major problems with the inventor's previous invention cited herein relates to excess chemical composition left as residue on the optical surface of the live-scan apparatus. The help minimize this residue, the user of that invention would need to rub their fingers together for several seconds so that the chemical composition would penetrate more fully into the skin.

Another problem with this previous invention relates to the methods of securing the porous ceramic to the reservoir material, to thus ensure an adequate interface thereof for the purpose of replenishing the surface of the pad with the chemical composition therein. The chemical composition would tend to attack the adhesive bond used to attach the porous ceramic to the reservoir material, or it would tend to attack the plastic clips or plastic bezel used to compress the porous ceramic or porous polyethylene to the reservoir material.

Yet another shortcoming of the prior invention is the tendency of the solvent composition thereof to attack the plastic components of the pad's case. Already mentioned are the pad's plastic clips or bezel, but in addition to these the plastic hinges, well, and lid are all subject to chemical attack. Chemical attack of plastics is typically manifested as either solvent action or as stress cracking.

A concern that the prior invention does not address is that of the transmission of harmful germs between people using the pad, as thousands of fingerprints treatments can be obtained from a single pad and so it is possible to transfer infectious germs from finger to finger.

My previous invention is also somewhat limited in its effectiveness because the index of refraction of the chemical composition is occasionally insufficient to control the light scattering characteristics of severely damaged fingerprint ridges.

There is therefore a need for improvements over the prior art that will overcome these shortcomings and limitations.

### SUMMARY OF THE INVENTION

The features of the present invention will be best understood by references to the following description taken in conjunction with accompanying drawings.

### BRIEF DESCRIPTION OF THE DRAWINGS

FIG. 3 is a cross-sectional view of an absorbent pad constructed according to the prior art, wherein the porous ceramic or polyethylene 1 is either bonded to the reservoir 2 by applying a bead of adhesive 4 or clamped to reservoir 2 by using a compression mechanism 5 to form an interface so that the chemical composition can replenish the top surface 3 of the pad. In the present invention, the reservoir 2 is inserted into the well or cavity 6 of the porous clay 1, as shown in FIG. 1 and in FIG. 2., instead of as in FIG. 3 wherein the reservoir 2 is a separate layer of material positioned below the porous body 1. The advantage gained is that there is no need for the adhesive 4, which is an added material cost, an added step in the assembly process, and which may be chemically attacked over time by the chemical composition contained within the pad.

FIG. 2 is a bottom view which shows how the reservoir 2 is pressed into the cavity 6 of the porous clay 1, and

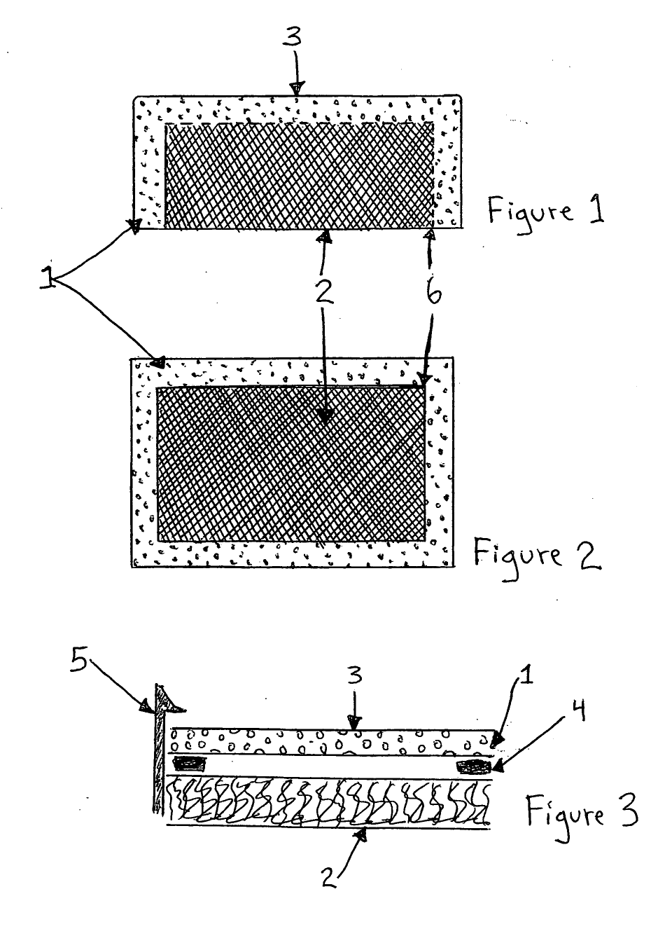

FIG. 1 is a cross-sectional view depicting how the reservoir 2 is pressed into the cavity 6 of the porous clay 1, so that the chemical composition can replenish the top surface 3 of the pad, and because reservoir 2 is dimensionally slightly larger than the cavity 6, being compressible, it is pressed into position where it can provide positive pressure against the cavity walls 6 of the porous clay 1. The advantage gained is that there is no need for the clamping mechanism 5 shown in FIG. 3, which is an added material cost, an added step in the assembly process, and which may be chemically attacked by the chemical composition contained with the pad. Another advantage is that the present invention permits the reservoir 2 and the porous clay 1 to be impregnated simultaneously with the chemical composition, rather than having to impregnate them independedly and then blot them of excess chemical as with the prior art. Yet another advantage is that pressure exerted by the fingers cannot create a pumping action that can cause excess chemical to ooze upward through or around the porous body 1 from the compressible reservoir 2 represented in the prior art in FIG. 3.

### DESCRIPTION OF THE PREFERRED EMBODIMENT

Referring again to FIG. 1 and to FIG. 2, the porous clay 1 is not a ceramic body nor is it polyethylene as described in the previous invention cited herein. Instead, the pore size of the clay is smaller, being less than 1 micron in diameter, and pore volume is consider-ably less, being only 7-8% at the most, and preferably lower. While these changes were made to further restrict the flow of chemical to the fingerprint ridges so that excess chemical could not build up quickly to a high level on the optical surface of the live-scan apparatus, as is problematic with the prior invention, it was not reasonably anticipated that the clay would be permeable enough to transfer sufficient chemical to the fingers, especially when the pad is being exhausted rapidly during heavy use periods. It is well understood by those skilled in the art that actual ceramics having a both a mean pore size less than one micron and a pore volume at 7-8 percent or less would be too low in permeability to continuously feed chemical to the fingers. Perhaps the unexpected result obtained through the clay is that the porosity of clay is characteristically binary, in other words, the mean porosity measurements are averaged from two species of pores within the clay. The microporous ceramic of the prior invention has a preferred pore volume within the range of 35-42 percent, and if this pore volume were present in the clay of the present invention, the result would be that far too much chemical would flow to the finger and overcoat it to the point that the fingerprint ridge lines would be unclear when captured by the live-scan apparatus and that the optical surface of the apparatus would become severely soiled after only a single application of the finger. Presently, microporous plastics, such as polyethylene, are not available in pore sizes small enough and with pore volumes low enough to be used with the present invention.

The fatty acid esters, and in particular isopropyl myristate, of the previous invention readily attack many thermoplastics used to mold the pad cases components. For example, this chemical dissolves acrylic and styrene plastics, and it causes polycarbonates to crack or crumble. This problem greatly restricts the choice of plastic materials that may be used the construct the pad. Non-fatty esters suitable for the present invention do not readily attack these plastics. For example, ethyl benzoate demonstrates that it produces little or no damage after thirty days of constant exposure in regards to both solvent attack and stress cracking.

The fatty acid esters, and in particular isopropyl myristate, have an index of refraction in the range of about 1.40 to about 1.45. While this range of refractive index performs quite well, it has been discovered that superior results are achieved using liquids of the present invention, which exhibit an index of refraction ranging from about 1.50 to about 1.60, and this is particularly true when a person has severely damaged fingerprints that scatter light more randomly. Listed below are a few examples of chemicals and their corresponding index of refraction, which may be used in the preferred embodiment of the present invention:

### Benzyl Ethyl Ether 1.493

### Benzyl Benzoate 1.579

### Benzyl Formate 1.505

### Benzyl Acetate 1.502

### Benzyl Methyl Ether 1.495

### Benzyl Salicylate 1.607

### Methyl Salicylate 1.538

### Methyl Benzoate 1.506

### Methyl Anthranilate 1.565

### Ethyl-4-Methyl Salicyalte 1.535

### Ethyl Salicylate 1.538

### Isoamyl Salicyalte 1.519

### Isoamyl Benzoate 1.504

### Ethyl Anthranilate 1.554

### Ethyl Benzoate 1.506

### Ethyl Benzyl Alcohol 1.517

### Ethyl Benzyl Aniline 1.594

### Butyl Benzoate 1.498

### Propyl Benzoate 1.501

### Butyl Salicylate 1.526

### Butyl Anthranilate 1.539

### Glycerol Triacetate (Triacetin) 1.566

One skilled in the art might expect to improve the performance of optical enhancement by means of increasing the refractive index of the chemical composition from the dispensing pad. However, the improvement is beyond what was reasonably anticipated by the inventor, quite surprisingly. Relative comparisons of live-scanned fingerprint images using chemicals having an index of refraction greater than 1.5 revealed that the chemicals that contain a benzene ring in their chemical structure provide greater enhancement than the fatty compounds (non-volatile oils), that is to say, a benzenoid liquid compound having an index of refraction of 1.5 gives results superior to oils having the same index of refraction of 1.5. The reason for this difference is not yet fully understood by the inventor, but a probable explanation might relate to the delocalized electrons that travel inside the benzene ring and produce some level of fluorescence when excited by the illumination employed by the live-scan device. Salicylates and anthranilates exhibit the highest levels of optical enhancements, and it is interesting to note that some of these are quite visibly fluorescent, particularly the anthranilic acid esters, although fluorescence invisible to the human eye may still be substantially visible to electronic cameras.

Another aspect of the chemical composition relating to the present inventions are those chemicals that have anti-microbial properties, and most preferably, those chemicals that are anti-microbial additives in cosmetics. In general, these are the alkyl esters of benzoic acid and of salicylic acid, and examples of these esters are propyl benzoate and methyl salicylate. Glycerol triacetate also is an anti-microbial agent used in cosmetics that also may be used in the invention because of its high index of refraction and because of its compatibility with thermoplastics. It is desirable to reduce the risk of transferring infectious germs by means of cosmetic additives already approved for use on the skin, which is an added benefit to using this invention.

Specific examples of the chemical composition can be taken from the list of chemicals with their refractive index. Typically a single chemical from that list is used alone, although mixtures of virtually any proportion may also be used.

It is not intended that the scope of the invention be limited to the particular embodi-ments and examples discussed above. Various alternatives, modifications, and equivalents will become apparent to those skilled in the art without departing from the spirit and scope of the invention as defined by the appended claims

What is claimed is:

1. A combination dispensing pad for applying a liquid chemical or mixture of liquid chemicals to the fingerprint area of a person's fingers prior to the placement thereof on the imaging platen of a live-scan electro-optical fingerprint-imaging apparatus to provide a clear optical boundary between the ridges defining the person's fingerprint and the surface of the platen comprising:
a substantially noncompressible microporous pad formed from clay material and having a pore volume of about 1 to 8 percent and a pore diameter within the range of about 0.1 to 1 microns: and
a liquid composition disposed within the pad, the composition consisting of one or more materials selected from the group of nonvolatile, non-fatty alkyl esters of benzoic, salicylic, and anthranilic acids; benzyl alcohol alcohol and its non-fatty, alkanoic acid esters and esters of benzoic, salicylic, and anthranilic acids and ethers of non-fatty alkyl esters; and the non-fatty alkanoic triesters of glycerol.

2. The dispensing pad and liquid chemical(s) of claim 1 wherein the absorbent pad includes a microporous top surface through which the chemical composition is supplied to the fingerprint area of the person's finger, the pad further having a pore volume within the range of about 1 to 8 percent and a mean pore diameter within the range of about 0.1 to 1.0 microns, the pad being substantially noncompressible in response to the pressure of a fingertip placed thereon for coating purposes.

3. The dispensing pad and chemical(s) of claim 2 wherein the absorbent pad further includes a reservoir positioned within or inside the microporous pad.

4. The dispensing pad and chemical(s) of claim 3 wherein the microporous pad is made of clay.

5. The dispensing pad and chemical(s) of claim wherein the chemical composition is selected from the group of non-fatty alkyl esters of benzoic, salicylic, and anthranilic acids.

6. The dispensing pad and chemical(s) of claim 5 wherein the esters are methyl benzoate, ethyl benzoate, ethyl-4-methyl benzoate, n-propyl benzoate, butyl benzoate isoamyl benzoate, salicylate, methyl salicylate, isopropyl salicylate, butyl salicylate, isoamyl salicylate, methyl anthranilate, ethyl anthranilate, isopropyl anthranilate, butyl anthranilate, and isoamyl anthranilate.

7. The dispensing pad and chemical(s) of claim 1 wherein the chemical composition is selected form the group of benzyl alcohol and its non-fatty alkyl esters.

8. The dispensing pad and chemical(s) of claim 7 wherein the chemical is benzyl alcohol.

9. The dispensing pad and chemical(s) of claim 7 wherein the benzyl alcohol esters are benzyl formate, benzyl acetate, benzyl propionate, benzyl butyrate, and benzyl valerate.

10. The dispensing pad and chemical(s) of claim 1 wherein the chemical composition is selected from the group of benzylbenzoate, benzyl salicylate, and benzyl anthranilate.

11. The dispensing pad and chemical(s) of claim 1 wherein the chemical composition is selected from the group of ethers of benzyl alcohol non-fatty alkyl esters.

12. The dispensing pad and chemical(s) of claim 11 wherein ethers are benzyl methyl ether, benzyl ethyl ether, benzyl propyl ether, benzyl butyl ether, and benzyl pentyl ether.

13. The dispensing pad and chemical(s) of claim 1 wherein the chemical composition is selected from the group of non-fatty, alkanoic triesters of glycerol.

14. The dispensing pad and chemical(s) of claim 13 wherein the triesters are glycerol triformate and glycerol triacetate.
